(19) United States
(12) Patent Application Publication
(10) Pub. No.: US 2004/0043207 A1
(43) Pub. Date: Mar. 4, 2004

(54) Lofty, stretchable thermal insulator

(76) Inventors: James G. Donovan, Norwell, MA (US); Adam J. Jaglowski JR., Swansea, MA (US)

Correspondence Address: FROMMER LAWRENCE & HAUG, 745 FIFTH AVENUE- 10TH FL., NEW YORK, NY, 10151, US

(21) Appl. No.: 10/229,477

(22) Filed: Aug. 28, 2002

(51) Int. Cl. B32B 3/26; D04H 1/00

(52) U.S. Cl. 428/304.4

(57) ABSTRACT

An insulation material composed of micro fibers and macro fibers which acts as a thermal insulator while being stretchable.

### FIELD OF THE INVENTION

The present invention is directed towards an insulation material, particularly a material which, while having insulative properties, is also stretchable.

### BACKGROUND OF THE INVENTION

There have been many efforts to create a synthetic insulation material which is a substitute for natural material. For example, down has always been a prized natural insulation material. Substitutes therefore are numerous. A material that has been particularly effective as a substitute for down is that set forth in U.S. Pat. No. 4,992,327 entitled “Synthetic Down”, the disclosure of which is incorporated herein by reference. In this patent there is disclosed a synthetic fiber thermal insulator material in the form of a batt. The cohesive fiber structure comprises a mixture of micro fibers and macro fibers of differing size and weight percentage. The resulting material has superior thermal insulation properties and has achieved widespread commercial success. It is currently being sold under the trademark Primaloft® by Albany International Corp.

It has become desirable that such thermal insulation material have additional properties for particular applications. For example, it would be desirable that the material be stretchable for use in, for example, stretchable athletic wear and gloves.

Stretchable fibers are well known and include a spandex fiber sold under the trademark Lycra® by Dupont. Spandex fibers typically provide the elasticity in most stretch garments.

Accordingly, while it is desirable to have a thermal insulation material which has the characteristics of that described in the aforesaid patent, it is also desirable that such material be stretchable whilst having a lofty nature.

### SUMMARY OF THE INVENTION

It is therefore a principal object of the invention to provide for a thermal insulation material in a batt or web form which is stretchable.

It is a further object of the invention to provide for a cohesive insulation material that can utilize existing fiber chemistry in providing stretchability.

It is a yet further object of the invention to provide for such a material which, while having superior insulation characteristics, may be made of synthetic fibers.

A further object of the invention is to provide for such a material which contains micro and macro fibers in a desired amount along with fibers that allow for the stretchability of the batt or web.

A still further object of the invention is to provide for a cohesive insulation material in which the degree of loft may be adjusted by the proportion of micro fibers and macro fibers.

These and other objects and advantages are provided by the present invention. In this regard, the present invention is directed towards an insulation material comprising micro and macro fibers in a desired percentage. These fibers are preferably synthetic, but can be a mixture with natural fibers such as cotton or wool. To provide for the stretchability of this material, a spandex type fiber is incorporated into the mixture. The spandex fibers comprise a fiber having a spandex core and a binder sheath and may be used to replace the conventional binder fibers of the type disclosed in the aforesaid patent or be used in conjunction therewith. The spandex core would have a significantly higher melting temperature than that of the binder sheath. The binder/spandex sheath/core fiber would provide the desired in-plane elastic stretch to the batt or web of insulation material.

Such a fiber will provide the mechanical link between most of the fibers in the batt or web. Additional binding may be provided by binder fibers per se to the extent needed and to the extent the desired stretchability is not diminished.

In addition, if it was desired to increase loft and maintain a high degree of in-plane elastic stretch, the amount or properties of macro fibers to micro fibers may be adjusted to provide for this.

### BRIEF DESCRIPTION OF THE DRAWINGS

Thus by the present invention, its objects and advantages will be realized the description of which should be taken in conjunction with the drawings wherein:

FIG. 1 is a side sectional view of the stretchable insulation material as a batt, incorporating the teachings of the present invention;

FIGS. 2A-2E are side sectional views of a fiber having a stretchable core and a coating or sheath made from a binder material, incorporating the teachings of the present invention; and

FIG. 3 is a flow chart for the manufacture of a bicomponent fiber, incorporating the teachings of the present invention.

### DETAILED DESCRIPTION OF THE PREFERRED EMBODIMENT

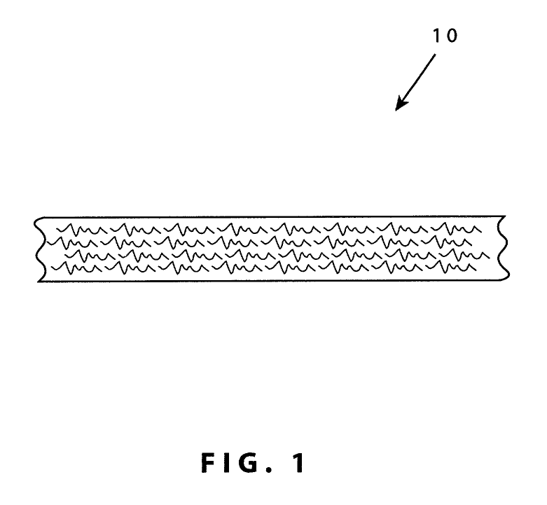

Turning now more particularly to the drawings, FIG. 1 shows generally the insulation material of the present invention which is in the form of a batt or web 10. The batt 10 is made from micro fibers and macro fibers which, to a certain degree, may be the type set forth in the aforesaid U.S. Pat. No. 4,992,327. In this patent there is set forth suggestions and examples of fiber diameter/weight-proportion that provide for a product having superior insulation characteristics. For example, the insulator material can be 70 to 95 weight percent of spun and drawn synthetic polymeric micro fibers having a diameter of from 3 to 12 microns mixed with from 5 to 30 weight percentage of synthetic polymeric macro fibers having a diameter of 12 to 50 microns. Such parameters are adopted in the present invention with the adjustments or modifications as herein discussed. Moreover, the insulation material of the present invention may be in an admixture with the insulation material disclosed in said patent resulting in a product having stretchability whilst providing thermal insulation.

In this regard, as noted in the above patent, the use of too great a proportion of macro fibers tends to reduce the overall thermal insulation properties. The problem, however, with a high percentage of micro fibers is in the mechanical stability of the batt, especially when wet. Thus there is a trade off; that being while it is desired to have a larger percentage of micro fibers to increase the insulation properties, the mechanical stability and recovery properties are diminished. The larger diameter fibers increase stability and recovery but reduce the insulation effect.

Accordingly, in the present invention it may be desirable to increase the percentage of macro fibers so as to increase the loft of the batt whilst increasing the degree of in-plane elastic stretch. The reason for this is that the macro fibers provide for the stretchability of the material. The more that are used, the greater the loft and the greater the stretch. This will be a trade off as to the insulating characteristics of the material. However, the proportions can be adjusted to achieve the desired effect in loft, insulation and stretchability.

Turning now to the composition of the bicomponent stretchable binder fiber, in this regard certain initial comments are in order. In general, it might be noted that, while composite yarns are known (see, for example, U.S. Pat. No. 4,159,618), the fiber of the present invention is intended to have a spandex core. Typically the lowest denier produced by a spandex manufacturer is about 10 denier. It is not economically attractive to produce low denier products (below 20 denier) with existing dry spinning technology.

Traditionally, dry spun spandex fiber is covered with polyester or nylon fiber via mechanically winding another fiber around the elongated spandex or by air entangling staple fibers around the elongated spandex fiber. It has been demonstrated that thermoplastic polyurethane (TPU) can be melt spun into a bicomponent fiber as core material with a nylon sheath. Commercially available spandex is compositionally a polyurethane-polyurea, and commercial TPUs are nearly 100% polyurethane composition.

As between commercially available spandex and TPU melt spun elastomeric fibers, the commercial spandex materials have been shown to be better elastomers. The spandex mechanical properties of elongation, tenacity, hysteresis, and set (fiber recovery) are significantly better than TPU's. The reason for the improved elasticity is the addition of the polyurea component, which allows for better phase separation of the hard and soft segments of the polyurethane molecule, resulting in better recovery and tenacity properties. Compositional modifications may be performed on TPU during melt spinning to effect physical property improvements, for example, the addition of a crosslinking agent to TPU upon melt extrusion. This process technology significantly improves TPU properties for use in selected textile markets.

Significant melt spinning operations for fine denier TPU products are being developed. Although melt spinning technology is not matured as compared to traditional dry spinning of spandex, like Dupont's Lycra®, it will be desirable, since melt spinning of TPU incurs a lower cost investment compared to dry spinning.

The commercial sources of spandex, in the higher denier range (>10) are composed of polyether-based materials, not polyester-based materials. The latter is more compatible with polyethylene terephthlate (PET). Also, commercial spandex contains a topical silicone finish for package stability and subsequent fiber processing. This is generally removed after fabric construction. Therefore, the adhesion is not expected to be very good without a scouring procedure and use of an adhesion promoter.

Very fine spandex fiber can be covered using the conventional spandex covering operations described above, although this approach is not compatible with staple fiber manufacture and processing, as required for incorporation into the insulating forms envisioned.

One approach however to the above is bicomponent melt spinning. This approach is viable to a point that the melt extruded TPU core meets the elastomeric requirements for use in a stretchable insulation product. TPU currently used in commercial melt spun fiber or TPU modified to optimize mechanical properties may however be used for the elastomeric core.

Another approach for manufacturing the bicomponent fiber is wire coating. Wire coating is a technique employed to manufacture electrical conductors for the electronics industry, which involves encapsulating an electrical conductor (copper wire) with an insulator (polyethylene). The processing technology would be generally as follows: a) the commercial source of spandex is pulled through a wire-coating die, b) the low melt PET binder is applied to the spandex surface as it exits the die, and c) the resulting bicomponent fiber is cooled in bath and then taken up onto a bobbin.

A similar approach is set forth in U.S. Pat. No. 4,159,618 to Sokaris, the disclosure of which is incorporated herein by reference. While this reference involves a high temperature resistant, composite yarn useful in the manufacture of woven and knitted fabrics for high temperature applications, such a technique could be modified and adapted to produce the useful inventive fibers/filaments described for the thermal insulator.

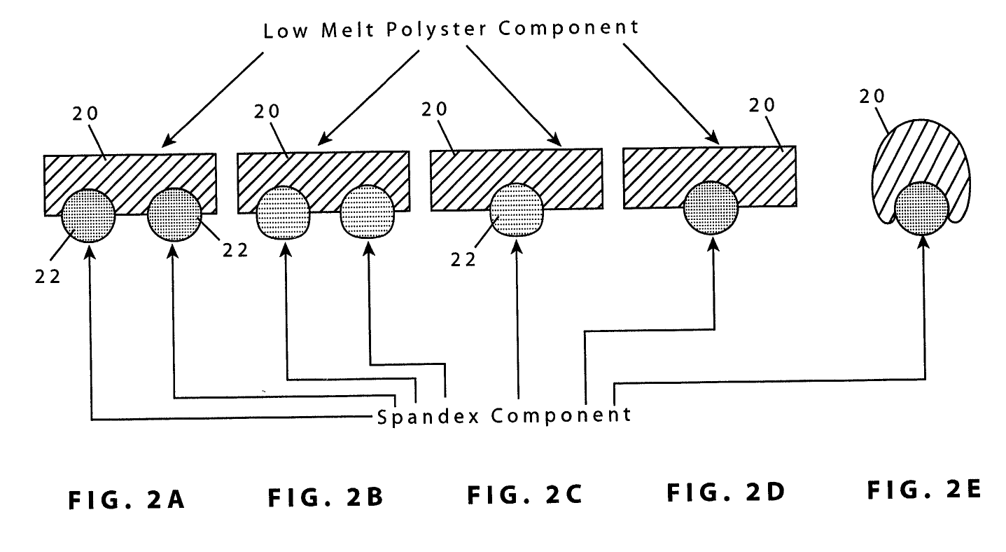

Another approach to create the bicomponent fiber would be as set forth in FIGS. 2A-2E. The bicomponent fiber could be fabricated out of a spandex core which is embedded into a U-shaped low melt thermoplastic polyester (PET) filament. In this regard a PET filament 20 is extruded having one or more U-shaped channels 22. The PET filament can take on a variety of shapes and sizes including square, rectangular, oblong or any other shape suitable for the purpose. Into the U-shaped channel(s) 22 are physically inserted the spandex core fiber 24. The bicomponent fiber 26 can then, if necessary, be heatset together to a certain degree as is necessary prior to incorporating them into the batt which makes up the insulation material. This can be done, since the melting point of the spandex core 24 is approximately 450° F. and that of the PET filament 22 is about 230° F.

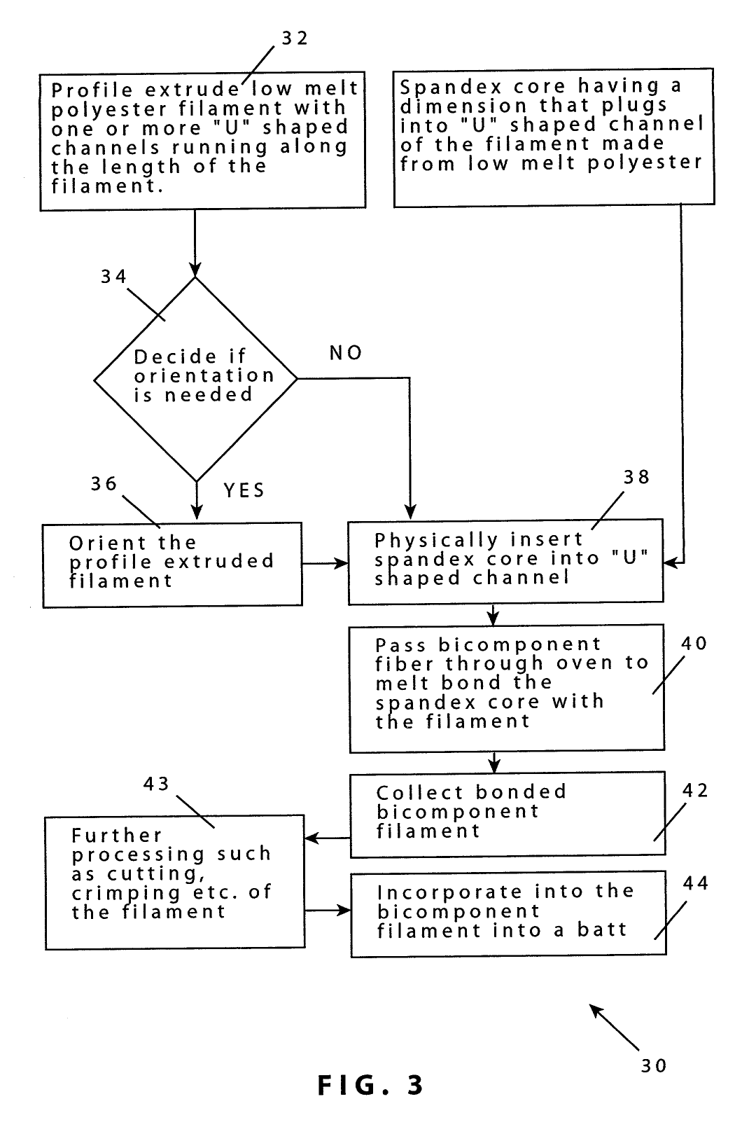

The process 30 with regard to the above is set forth in FIG. 3. In this regard, box 32 illustrates a step of extruding a low melt polyester (e.g. PET) filament having one or more U-shaped channels. The next step 34 would be to ensure that the filament is properly oriented (drawn) if necessary. The spandex core or cores, if more than one U-shaped channel is used, are then inserted 38 into the channel(s). If there is not sufficient bearing or frictional force to maintain the core in the channel, then, if necessary, the bicomponent fiber can be partially heated 40 to create a bond between the spandex core and the sheath. The fiber so formed can now be collected 42 and after cutting and crimping etc. 43 ultimately incorporated into a batt 10 by carding and heatsetting thereby creating a cohesive stretchable insulation product.

While there is a mis-match in elasticity between the core and the sheath, a relatively thin sheath will probably minimize difficulties, allowing breaks in the sheath to accommodate the greater elongation of the core. Sheath breaks should not affect, to a detrimental degree, the quality of the batt.

Note, while a bicomponent fiber having a spandex core and binder sheath would be effective as a component of an improved insulation material which is lofty and stretchable, variations are envisioned. For example, a mixture of micro fibers, macro-spandex fibers, binder fibers, and/or fibers as set forth in U.S. Pat. No. 4,992,327 in proper proportions, may provide a product having the desired characteristics. Also while a spandex core has often been referred to herein, a TPU core can also be used in place thereof or cores of other elastomeric material suitable for the purpose may also be used. In addition, although while the present invention focuses on macro fibers as having the spandex or TPU core, it is envisioned that this may also apply to micro fibers at some point.

Thus by the present invention its objects and advantages are realized, and although preferred embodiments have been disclosed and described in detail herein, its scope and objects should not be limited thereby; rather its scope should be determined by that of the appended claims.

What is claimed is:

1. A fiber insulation material in the form of a cohesive structure, which structure comprises an assemblage of:
fibers having a first composition;
fibers having a second composition;
at least one of said compositions being elastomeric; and
means to bind said fibers together into a cohesive structure which acts as an insulator whilst being stretchable.

2. The insulation material as claimed in claim 1 wherein said material comprises micro fibers and macro fibers.

3. The insulation material as claimed in claim 2 wherein said macro fibers are composed of spandex or TPU.

4. The insulation material as claimed in claim 3 wherein said macro fibers are bicomponent fibers having a core and a sheath wherein said core is composed of spandex or TPU and said sheath is composed of a binder.

5. The insulation material as claimed in claim 1 wherein at least one of said fibers is a macro fiber having a core and a sheath wherein said core is made of spandex or TPU and said sheath is composed of a binder with said spandex or TPU providing stretchability and with said binder binding said fibers together.

6. The insulation material as claimed in claim 4 wherein said core is mechanically inserted into the sheath and bound thereto.

7. The insulation material as claimed in claim 5 wherein said core is mechanically inserted into the sheath and bound thereto.

8. A synthetic fiber thermal insulation material in the form of a cohesive fiber structure, which structure comprises an assemblage of:
approximately 70 to 95 weight percent of spun and drawn, synthetic polymeric microfibers having a diameter of from from 3 to 12 microns; and
approximately 5 to 30 weight percent of synthetic polymeric macrofibers having a diameter of 12 to 50 microns, in an admixture with:
bicomponent fibers having a core and a sheath wherein said core is composed of spandex or TPU and said sheath is composed of a binder.

9. The insulation material as claimed in claim 8 wherein said spandex or TPU provides stretchability and said binder binding said fibers together.

10. The insulation material as claimed in claim 9 wherein said core is mechanically inserted into the sheath and bound thereto.

11. A method of making a bicomponent fiber which is stretchable comprising the steps of:
providing a wire-coating die device;
providing material made of spandex or TPU;
pulling the spandex or TPU through the wire-coating die;
applying a PET binder to the spandex or TPU surface as it exits the die; and coating the resulting bicomponent fiber.

12. A method of making an insulation material in the form of a cohesive fiber structure, comprising the steps of:
combining the bicomponent fibers of claim 11 with other fibers to form a batt of material.

13. The method according to claim 12 which includes the step of providing said other fibers which are from 70 to 95 weight percent of spun and drawn, synthetic polymeric microfibers having a diameter of from 3 to 12 microns; and from 5 to 30 weight percent of synthetic polymeric macrofibers having a diameter of 12 to 50 microns,

14. A method of making a bicomponent fiber which is stretchable, comprising the steps of:
extruding low melt polyester filament with one or more “U” shaped channels running along the length of the filament;
orienting the extruded filament as is necessary;
inserting a spandex or TPU core into “U” shaped channel to create a bicomponent fiber;
and heating the bicomponent fiber to bond the spandex or TPU core with the filament.

15. The method of making an insulation material in the form of a cohesive fiber structure, comprising the steps of:
combining the bicomponent fibers of claim 14 with other fibers to form a batt of material.

16. The method according to claim 15 which includes the step of: providing said other fibers which are from 70 to 95 weight percent of spun and drawn, synthetic polymeric microfibers having a diameter of from 3 to 12 microns; and from 5 to 30 weight percent of synthetic polymeric macro fibers having a diameter of 12 to 50 microns.

17. The method according to claim 14 which includes the step of:
forming the TPU core by melt spinning.

18. A method of making a bicomponent fiber which is stretchable comprising the steps of:
providing a polyester material;
providing TPU;
and melt spinning said polyester material and TPU into the bicomponent fiber.
